(19) United States
(12) Patent Application Publication
(10) Pub. No.: US 2025/0346507 A1
(43) Pub. Date: Nov. 13, 2025

(54) SILICATE ION REMOVAL DEVICE, SILICATE ION REMOVAL SYSTEM, AND SILICATE ION REMOVAL METHOD

(71) Applicants: Samsung Electronics Co., Ltd., Suwon-si (KR); Seoul National University R&DB Foundation, Seoul (KR)

(72) Inventors: Jinhyeok Jang, Suwon-si (KR); Changha Lee, Suwon-si (KR); Yunho Kim, Suwon-si (KR); Ki-Myeong Lee, Suwon-si (KR); Sungjune Lee, Suwon-si (KR); Alim Jang, Suwon-si (KR); Younghun Kim, Suwon-si (KR); Samjong Choi, Suwon-si (KR)

(21) Appl. No.: 18/982,216

(22) Filed: Dec. 16, 2024

(30) Foreign Application Priority Data
May 7, 2024 (KR) 10-2024-0060075
Jul. 3, 2024 (KR) 10-2024-0087785

(51) Int. Cl. C02F 1/469; C02F 1/461; C02F 101/10; C02F 103/34

(52) U.S. Cl. CPC C02F 1/4693; C02F 1/46109; C02F 2001/46133; C02F 2101/10; C02F 2103/346; C02F 2201/46115; C02F 2201/46135; C02F 2201/46145; C02F 2201/4618

(57) ABSTRACT

A silicate ion removal device according to an embodiment is a device for removing silicate ions from fluid containing silicates. The silicate ion removal device comprises a positive electrode comprising a porous carbon electrode, a negative electrode spaced apart from the positive electrode and comprising graphite, a current collector on one side of each of the positive electrode and the negative electrode and configured to supply power to the positive electrode and the negative electrode, a flow path configured such that the fluid is configured to flow between the positive electrode and the negative electrode, and a cation exchange membrane between the positive electrode and the flow path, wherein the positive electrode is configured to adsorb the silicate ions.

### CROSS-REFERENCE TO RELATED APPLICATION

This application claims priority to and the benefit of Korean Patent Application No. 10-2024-0060075, filed May 7, 2024, and Korean Patent Application No. 10-2024-0087785, filed Jul. 3, 2024, at the Korean Intellectual Property Office, the entire contents of which are incorporated herein by reference.

### BACKGROUND OF THE INVENTION

### (a) Field of the Invention

The present disclosure relates to a silicate ion removal device, a silicate ion removal system, and a silicate ion removal method.

### (b) Description of the Related Art

As semiconductor technology becomes more sophisticated and refined, fine impurities contained in materials used in the semiconductor manufacturing process are affecting product quality. Since small impurities may cause defects in products, it is desirable to reduce or minimize impurities in chemicals supplied to the semiconductor manufacturing process.

In particular, there may be issues with silicate-based particles remaining at the chemical use stage.

Many of these issues may be caused by residual silicate ion in the chemicals that are not filtered out, but that are present in the chemicals and are then released during the semiconductor manufacturing process.

Currently, semiconductor chemical materials are purified using filters by material companies up to the manufacturing stage, but the filter technology used has reached its technical limits.

Specifically, a pore size of 1 to 2 nm is used, however, extremely fine silicate ionic particles cannot be removed, and as a result, defects may continue to occur.

However, when removing silicate ions in aqueous solution using the conventional CDI (capacitive deionization) method, as the pH of the aqueous solution decreases during the ion adsorption process, the state of the silicate ions in the aqueous solution changes to solid-phase silicate, making it difficult to remove silicate ions through ion adsorption in aqueous solution.

### SUMMARY OF THE INVENTION

Embodiments of the present disclosure may address the above issues, and provide a silicate ion removal device, a silicate ion removal system, and a silicate ion removal method that may be capable of increasing the efficiency of silicate removal from the aqueous solution through adsorption of the silicate ions by maintaining or increasing the pH of the aqueous solution so that the silicate ions are present in the aqueous solution as silicate ions, during the process of removing silicate ions from the aqueous solution.

A silicate ion removal device according to some embodiments is a device for removing silicate ions from fluid containing silicates comprising a positive electrode comprising a porous carbon electrode, a negative electrode spaced apart from the positive electrode and comprising graphite, a current collector on one side of each of the positive electrode and the negative electrode and configured to supply power to the positive electrode and the negative electrode, a flow path configured such that the fluid flows through the flow path between the positive electrode and the negative electrode, and a cation exchange membrane between the positive electrode and the flow path, wherein the positive electrode is configured to adsorb the silicate ions.

A silicate ion removal system according to some embodiments comprises an inlet, a silicate ion removal device configured to receive a fluid from the inlet and to remove silicate ions from the fluid, and an outlet configured to flow the fluid treated in the silicate ion removal device out of the outlet, wherein the silicate ion removal device comprises a positive electrode comprising a porous carbon electrode configured to adsorb the silicate ion, a negative electrode spaced apart from the positive electrode and comprising graphite, a current collector on one side of each of the positive electrode and the negative electrode, the current collector being configured to supply power to the positive electrode and the negative electrode, a flow path configured such that the fluid flows between the positive electrode and the negative electrode, and a cation exchange membrane between the positive electrode and the flow path.

A silicate ion removal method according to some embodiments comprises flowing a fluid containing silicate into an inlet and into a flow path of a silicate ion removal device, supplying voltage to a positive electrode and a negative electrode by a pair of current collectors, generating hydroxide ions from the fluid with the negative electrode, wherein the negative electrode comprises graphite, adsorbing the silicate ions in the fluid on the positive electrode, wherein the positive electrode comprises a porous carbon electrode, and flowing out the fluid from which the silicate has been removed through an outlet.

According to some embodiments, it maybe possible to increase the removal rate of impurities including silicate ions in chemical materials used in the semiconductor manufacturing process, thereby reducing or minimizing the occurrence of product defects.

### BRIEF DESCRIPTION OF THE DRAWINGS

FIG. 1 illustrates a silicate ion removal device according to an embodiment.

FIG. 2 illustrates a silicate ion removal system according to an embodiment.

FIG. 3 illustrates the configuration of a silicate ion removal system according to an embodiment.

FIG. 4 is a graph shown to describe the distribution of silicate ions according to pH changes.

FIGS. 5A to 5B are graphs shown to describe the change in pH in an aqueous solution over time in the process of using conventional CDI and MCDI methods.

FIG. 6 is a graph shown to describe the effect of silicate ion removal when using the conventional CDI method.

FIG. 7 is a graph shown to compare and describe the change in pH according to voltage when using a silicate ion removal device and CDI and MCDI methods according to an embodiment.

FIG. 8 is a graph shown to compare and describe the removal rate of silicate ions according to voltage when using a silicate ion removal device and CDI and MCDI methods according to an embodiment.

FIGS. 9A to 9C are graphs shown to compare and describe the removal rate of 10 ppm silicate ions when using a silicate ion removal device and CDI and MCDI methods according to an embodiment.

FIGS. 10A to 10C are graphs shown to compare and describe the removal rate of 1 ppm silicate ions when using a silicate ion removal device and CDI and MCDI methods according to an embodiment.

FIGS. 11 to 13 illustrate a silicate ion removal method according to an embodiment.

### DETAILED DESCRIPTION OF THE EMBODIMENTS

Hereinafter, the present disclosure will be described in detail with reference to the accompanying drawings, in which embodiments of the present disclosure are shown. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

In addition, size and thickness of each constituent element in the drawings are arbitrarily illustrated for better understanding and ease of description, and the following embodiments are not limited thereto. In the drawings, the thickness of layers, films, panels, regions, etc., are exaggerated for clarity. In the drawings, the thickness of some layers and regions may be exaggerated for ease of description.

Throughout this specification and the claims that follow, when it is stated that an element is “coupled” to another element, it includes not only the case of being “directly coupled” but also “indirectly coupled” with another element therebetween. In addition, unless explicitly described to the contrary, the word “comprise,” and variations such as “comprises” or “comprising,” should be understood to imply the inclusion of stated elements but not the exclusion of any other elements.

It should be understood that when an element such as a layer, film, region, or substrate is referred to as being “on” or “above” another element, it can be “directly on” the other element or intervening elements may also be present. In contrast, when an element is referred to as being “directly on” another element, there are no intervening elements present. Further, when an element is referred to as being “on” or “above” a reference element, it can be positioned above or below the reference element, and it is not necessarily referred to as being positioned “on” or “above” it in a direction opposite to gravity.

Further, throughout the specification, the phrase “in a plan view” or “on a plane” means viewing a target portion from the top, and the phrase “in a cross-sectional view” or “on a cross-section” means viewing a cross-section formed by vertically cutting a target portion from the side.

Conventionally used water treatment methods include a capacitive deionization (CDI) method and a membrane capacitive deionization (MCDI) method.

First, capacitive deionization (CDI) is a technology mainly used for desalination of water. The CDI method generally uses a pair of porous carbon electrodes and has a structure in which water flows through a spacer channel (flow path) between two electrodes.

The CDI method includes an adsorption process in which ions in water are stored in electrode pores by an electric double layer formed inside a carbon electrode when voltage is applied, and a desorption process in which the stored ions are released by applying a reverse voltage to regenerate the electrode.

The CDI method is a widely used technology because it has a long lifespan and is easy to maintain because it uses a non-Faraday process, a physical method, rather than relying on a Faraday process such as electrolysis.

However, in the case of the CDI method, there is a disadvantage in that the charge efficiency and adsorption capacity are reduced due to the below-mentioned co-ion repulsion effect. The co-ion repulsion effect refers to the effect in which ions with an unwanted opposite charge along with the target ions move near the electrode and are then pushed out again by the electrode.

Next, membrane capacitive deionization (MCDI) is a technology that adds an ion exchange membrane to the CDI.

The MCDI method is a method that overcomes the shortcomings of the existing CDI method, and has the advantage of improving adsorption efficiency by reducing or preventing adsorption and release of co-ions to the electrode through an ion exchange membrane.

The above-described method is a generally used technology in the water treatment process. However, when attempting to remove silicate ions in an aqueous solution using the above method, the removal rate of silicate ions is low.

This is because during the ion adsorption process of CDI and MCDI, the pH of the aqueous solution decreases. In other words, silicate ions in an aqueous solution change into solid-phase silicate rather than into ions at low PH, because the silicate that has changed to solid is not adsorbed onto the electrode.

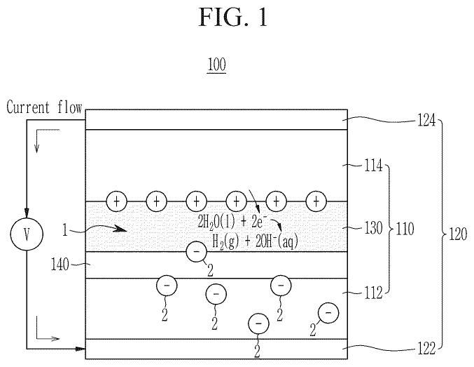

FIG. 1 illustrates a silicate ion removal device according to an embodiment.

As illustrated in FIG. 1, a silicate ion removal device 100, a silicate ion removal system 200, and a silicate ion removal method according to the present disclosure attempt to maintain or increase the pH of the aqueous solution in the process of removing silicate ions 2 from the aqueous solution.

Maintaining the pH of the aqueous solution at 7 or higher ensures that the silicate ions are present in the state of silicate ions in the aqueous solution, thereby increasing the efficiency of silicate removal in the aqueous solution through the adsorption of silicate ions.

Hereinafter, the silicate ion removal device 100, the silicate ion removal system 200, and the silicate ion removal method according to an embodiment of the present disclosure will be described in more detail with reference to the drawings.

First, fluid 1 in the present disclosure refers to a solution containing chemicals used in a semiconductor process. However, the chemicals do not mean only chemicals used in semiconductor processes, and may include all solutions containing silicates.

Additionally, the silicate ions 2 have an anionic form and may include SiO(OH)₃⁻ and SiO₄⁴⁻. SiO(OH)₃⁻ and SiO₄⁴⁻ are examples of silicate ions 2, and as used herein, the silicate ions 2 refer to any anionic form having Si (silicon) and O (oxygen) elements.

As shown in FIG. 1, the silicate ion removal device 100 according to the present disclosure is a device that removes the silicate ions 2 from the fluid 1 containing silicates.

The silicate ion removal device 100 includes an electrode 110 having a positive electrode 112 including a porous carbon electrode, and a negative electrode 114 spaced apart from the positive electrode 112 and including graphite.

Therefore, the negative electrode 114 according to the present disclosure uses graphite according to some embodiments.

In addition, the silicate ion removal device 100 may include a current collector 120 on one side of each electrode 110 to supply power to each electrode 110, a flow path 130 through which the fluid 1 flows between the positive electrode 112 and the negative electrode 114, and a cation exchange membrane 140 between the positive electrode 112 and the flow path 130.

As shown, the anionic silicate ions 2 may be adsorbed onto the positive electrode 112. The positive electrode 112 may serve to adsorb the silicate ions 2.

The cation exchange membrane 140 between the positive electrode 112 and the flow path 130 may filter only the silicate ions 2 among the ions adsorbed on the positive electrode 112.

Through the cation exchange membrane 140, it may be possible to reduce or prevent the co-ion repulsion effect from occurring.

The co-ion repulsion effect refers to the effect in which, among the silicate ions 2, ions (cations) with an opposite charge to the silicate ions 2 come near the positive electrode 112 and are then pushed out by the positive electrode 112.

The cation exchange membrane 140 may improve the adsorption rate of the silicate ions 2 by reducing or minimizing the phenomenon in which the silicate ions 2 are not adsorbed to the positive electrode 112 due to the co-ion repulsion effect.

The cation exchange membrane 140 serves to increase the efficiency of the forward reaction in which negatively charged ions are adsorbed to the positive electrode 112 and to suppress side reactions that occur simultaneously.

The current collector 120 may include a positive electrode current collector 122 close to the positive electrode 112 and a negative electrode current collector 124 close to the negative electrode 114. The current collector 120 may serve to supply power to each electrode 110.

Cations may be adsorbed on the negative electrode 114, as shown in FIG. 1.

Additionally, the negative electrode 114 according to the present disclosure is graphite (C). Accordingly, a hydrogen generation reaction occurs at the negative electrode 114, which serves to increase the pH of the fluid 1.

Anions from graphite (C) react with the fluid 1 flowing through the flow path 130 to generate hydroxide ions (OH-), and hydroxide ions (OH) generated at the negative electrode 114 serve to maintain or increase the pH in the fluid 1.

In the case of the conventional CDI method, as the process of adsorption of the silicate ions 2 to the positive electrode 112 progresses, the pH of the fluid 1 gradually decreases and becomes acidic. In this acidity, the silicate ions 2 change into solid-phase silicate.

Since the solid-phase silicate does not contain ions, it is not adsorbed to the positive electrode 112, and thus the silicate ions 2 in the fluid 1 cannot be removed by a method using ion separation and adsorption. Accordingly, hydroxide ions (OH⁻) may be generated to reduce or prevent the pH of the fluid 1 from being lowered.

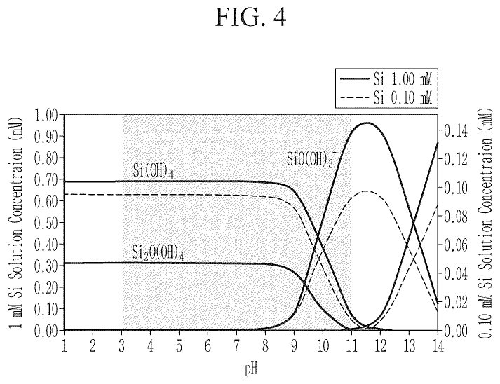

The change in pH in the fluid 1 as the ion adsorption process proceeds, the change in concentration of the silicate ions 2, and the change in silicate ions 2 removal rate with pH change will be described below with reference to FIGS. 4 to 10.

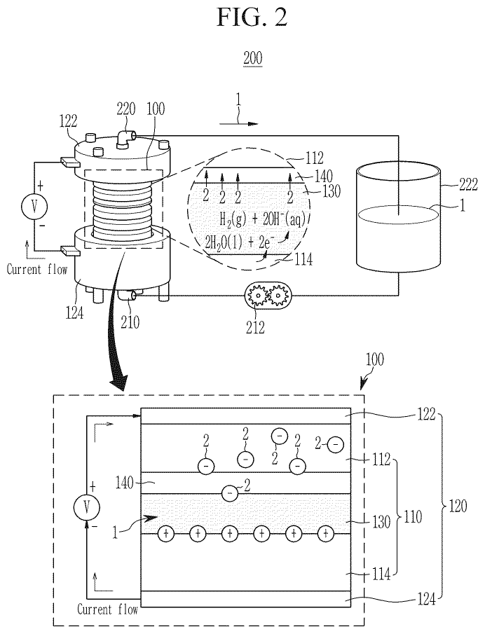

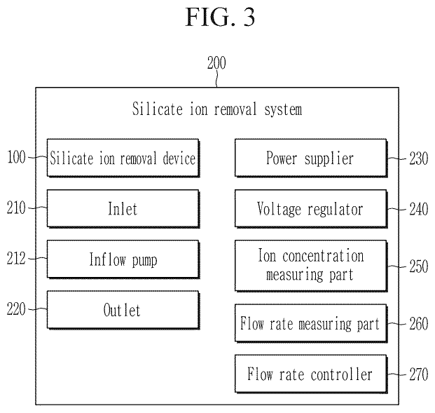

FIG. 2 illustrates a silicate ion removal system according to some embodiments, and FIG. 3 illustrates the configuration of a silicate ion removal system according to some embodiments.

As shown in FIGS. 2 and 3, the silicate ion removal system 200 according to the present disclosure may include an inlet 210, the silicate ion removal device 100 that is configured to remove the silicate ions 2 from the fluid 1 inflowed from the inlet 210, and an outlet 220 that flows silicate-treated fluid 1 out of the silicate ion removal device 100.

As in FIG. 1, the silicate ion removal device 100 includes the electrode 110.

The electrode 110 may include the positive electrode 112 which includes a porous carbon electrode that is configured to adsorb the silicate ions 2, and the negative electrode 114 spaced apart from the positive electrode 112 and includes graphite.

In addition, the silicate ion removal device 100 may include the current collector 120 on one side of each electrode 110 to supply power to each electrode 110, the flow path 130 through which the fluid 1 flows between the positive electrode 112 and the negative electrode 114, and the cation exchange membrane 140 between the positive electrode 112 and the flow path 130.

First, the positive electrode 112 of a pair of electrodes 110 may serve to adsorb the silicate ions 2. The distance between the pair of electrodes 110 may be between 1 μm and 1 mm.

Silicates are present as silicate ions 2 in the anionic form in the fluid 1 at pH 7 or higher, and are present as solid-phase silicate, not in the anionic form, in acids. Specifically, silicates are present as silicate ions 2 in the anionic form within a certain range of pH 8 or higher.

The negative electrode 114 according to the present disclosure is made of graphite (C), and the graphite (C) electrode generates hydroxide ions (OH) from the fluid 1 and serves to maintain the fluid 1 at pH 7 or higher.

That is, since silicates are present as the silicate ions 2 at pH 7 or higher, the silicates may be removed by adsorption to the positive electrode 112.

The cation exchange membrane 140 may allow only silicate ions 2 among the ions adsorbed on the positive electrode 112 to pass through.

The current collector 120 may include a positive electrode current collector 122 close to the positive electrode 112 and a negative electrode current collector 124 close to the negative electrode 114.

Since the silicate ion removal device 100 included in the silicate ion removal system 200 shown in FIGS. 2 and 3 has the same configuration as that in FIG. 1, detailed description of the same configuration will be omitted.

As shown in FIGS. 2 and 3, the silicate ion removal system 200 may further include a storage tank 222.

The fluid 1 from which the silicate ions 2 have been removed, flowing out through the outlet 220, may be stored in the storage tank 222.

In FIG. 2, it is shown that the fluid 1 flowing out from the outlet 220 is stored in the storage tank 222, and the fluid 1 is supplied from the storage tank 222 back to the inlet 210.

However, it is not limited thereto, and each of the storage tank 222 in which the fluid 1 to be supplied to the inlet 210 and the storage tank 222 in which the fluid 1 to be treated and flowed out of the outlet 220 may be in the form of a separate tank.

As shown in FIG. 2, the silicate ion removal system 200 may further include an inflow pump 212 that flows the fluid 1 into the inlet 210.

The inflow pump 212 may increase the flow velocity and flow rate of the fluid 1 by applying pressure to the fluid 1 supplied from the storage tank 222 to the silicate ion removal device 100.

Additionally, the silicate ion removal system 200 may include a power supplier 230 that supplies a predetermined voltage to the silicate ion removal device 100. Additionally, the silicate ion removal system 200 may further include a voltage regulator 240 that regulates the supplied voltage.

Depending on the embodiments, the silicate ion removal system 200 may further include an ion concentration measuring part 250 that measures the concentration of the silicate ions 2 contained in the fluid 1.

The ion concentration measuring part 250 may measure the concentration of the silicate ions 2 in at least one fluid 1 flowing into the inlet 210 and the fluid 1 flowing out of the outlet 220.

By measuring the concentration of the silicate ions 2 in the inflow and outflow fluid 1, the removal rate of the silicate ions 2 in the fluid 1 may be determined.

The silicate ion removal system 200 may further include a flow rate measuring part 260 that measures the flow rate of the fluid 1.

The flow rate measuring part 260 may measure the flow rate of at least one fluid 1 flowing into the inlet 210 and the fluid 1 flowing out of the outlet 220. In addition, the silicate ion removal system 200 may further include a flow rate controller 270 that controls the flow rate of the fluid 1 flowing into the inlet 210.

FIGS. 4 to 10 are graphs showing that the silicate removal effect is improved compared to the related art when using the silicate ion removal device 100 and the silicate ion removal system 200 according to the present disclosure.

Referring to FIGS. 4 to 10, in the process of using the conventional capacitive deionization (CDI), membrane capacitive deionization (MCDI), and the silicate ion removal system 200 according to the present disclosure, the pH change of the fluid 1, the concentration change of the silicate ions 2, and the removal rate of the silicate ions 2 according to each method will be compared.

First, FIG. 4 is a graph shown to describe the distribution of silicate ions according to pH changes.

Referring to the graph of FIG. 4, the silicate ions 2 are indicated as SiO(OH)₃, and the solid-phase silicate is indicated as Si(OH)₄ and Si₂O(OH)₄.

The solid line shows the silicate concentration of 1.00 mM, and the dotted line shows the silicate concentration of 0.10 mM, which is 1/10 of the solid line.

As a result, regardless of the initial concentration of silicate, it can be seen that the silicate ions 2 existing in ionic form are present at pH 8 or higher. It can be seen that in the range of pH 10 or higher, the silicate ions 2 predominate, and in the range of pH 8 or less, the silicate ions 2 lose their charge and are present in the form of solid-phase silicates, Si(OH)₄ and Si₂O(OH)₄.

That is, from FIG. 4, it can be seen that the form of the silicate ions 2 increases when the pH is 8 or higher.

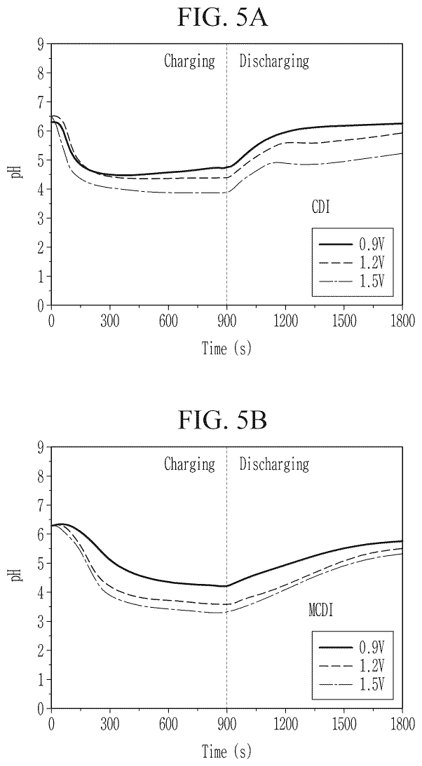

FIGS. 5A to 5B are graphs that shows the change in pH in an aqueous solution over time in the process of using conventional CDI and MCDI methods.

FIG. 5A shows the result according to the CDI method, and FIG. 5B shows the result according to the MCDI method.

From the initial point of time 0(s) to the point of time 900(s) can be seen as a charging process, and from the point of time 900(s) to the point of time 1800(s) can be seen as a discharging process. The charging process refers to the forward reaction, and the discharging process refers to the reverse reaction of the forward reaction.

It can be seen that both FIGS. 5A and 5B have similar patterns at voltages of 0.9V, 1.2V, and 1.5V.

In FIG. 5A, it can be seen that the pH is about 6.5 at the initial point in the CDI method, and as time passes, the pH decreases during the charging process. During the discharging process, the pH increases some, but not more than pH 7.

In FIG. 5B, as in FIG. 5A, show that the pH is about 6.3 at the initial point, and as time passes, the pH decreases during the charging process. During the discharging process, the pH increases, but not more than pH 7.

Through the graphs of FIGS. 5A to 5B, it can be seen that in the case of the conventional CDI and MCDI methods, the pH decreases over time from the initial concentration at 7 or less during both charging and discharging.

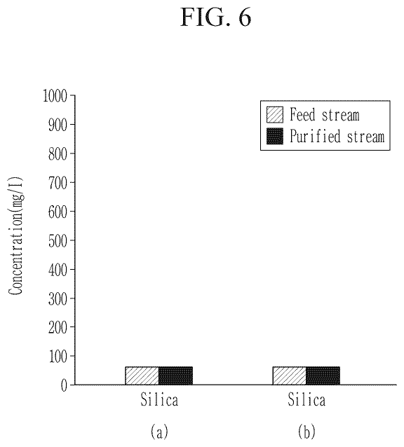

The graphs in FIG. 6 are shown to describe the effect of silicate ion removal when using the conventional CDI method.

Graph (a) in FIG. 6 shows a case where the flow rate of the fluid 1 containing silicate is 2 L/min, and graph (b) in FIG. 6 shows a case where the flow rate of the fluid 1 containing silicate is 4 L/min.

Graphs (a) and (b) in FIG. 6 show that the concentration of silicate in the fluid 1 remains the same, regardless of the flow rate of the fluid 1, and it can be seen that when using the conventional CDI method, silicate is not removed.

Feed stream refers to the fluid flowing through the flow path through which the fluid 1 enters the CDI processing device before being treated by the CDI method.

Purified stream refers to the fluid flowing through the outflow flow path after going through a CDI-type treatment process.

The vertical axis indicates the concentration of silicate in the fluid 1, and through FIG. 6, it can be seen that silicate contained in the fluid 1 is not removed by the conventional CDI method.

Summarizing the results in the graph described above, in the conventional CDI method, the fluid 1 becomes acidic during the process. In acidic conditions, silicates are present in solid phase rather than ionic form, so when ion adsorption method is used, silicates are not removed.

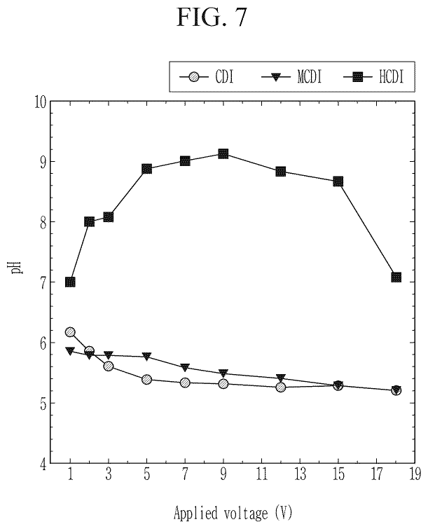

FIG. 7 is a graph shown to compare and describe the change in pH according to voltage when using a silicate ion removal device and the CDI and MCDI methods according to some embodiments.

In the silicate ion removal system 200 according to the present disclosure, a non-Faraday reaction occurs at the positive electrode 112, in which charged ions are adsorbed to the electrode, and a Faraday reaction occurs at the negative electrode 114, in which hydroxide ions (OH) are generated to bring the fluid 1 to basic conditions.

The silicate ion removal system 200 according to the present disclosure has a hybrid form in which the positive electrode 112 and the negative electrode 114 have an asymmetric reaction, which is why the silicate ion removal system 200 is also referred to as hybrid capacitive deionization (HCDI) in the description below.

First, in the case of CDI and MCDI, it can be seen that the pH decreases even when the voltage is gradually increased.

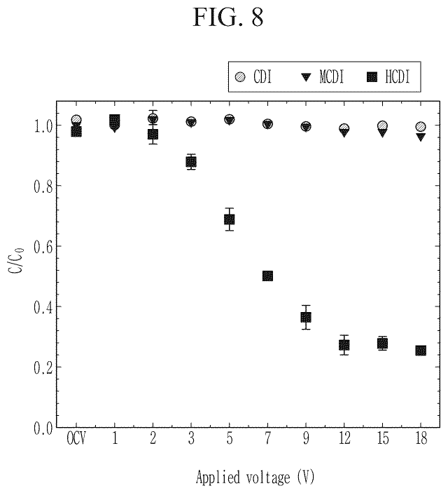

In FIGS. 5A to 5B described above, the change in pH over time was examined, and when FIGS. 5 and 7 are combined, it can be seen that in the case of CDI and MCDI, the pH decreases as the reaction progresses, regardless of the flow of time and changes in voltage. That is, as the proportion of the silicate ions 2 in the fluid decreases, it can be expected that the proportion of silicates removed through ion adsorption will decrease (see FIG. 8).

In contrast, in the silicate ion removal system 200 (HCDI) according to the present disclosure, unlike CDI and MCDI, the pH increases when the voltage is increased to a certain value, but the pH decreases after a certain value. However, even if the pH is lowered, it can be seen that the initial pH value is maintained or increased.

That is, under conditions of pH 7 or higher, the proportion of the silicate ions 2 increases, so it can be expected that the silicate removal rate will increase (see FIG. 8).

FIG. 8 is a graph shown to compare and describe the removal rate of silicate ions according to voltage when using a silicate ion removal device and CDI and MCDI methods according to some embodiments.

The vertical axis indicates the current concentration of silicate/initial concentration of silicate, and the horizontal axis indicates voltage. The voltage range is 1 to 18 V.

First, in the case of CDI and MCDI, even if the voltage is increased, the current concentration of silicate is maintained close to 1, confirming that silicate is hardly removed when using the CDI or MCDI method.

It can be seen that in the silicate ion removal system 200 (HCDI) according to the present disclosure, as the voltage is increased, the current concentration of silicate gradually decreases. Accordingly, it can be seen that silicate is removed from the fluid 1.

As a result, through FIG. 8, it can be seen that the removal rate of the silicate ions 2 is higher when using the silicate ion removal system 200 (HCDI) according to the present disclosure compared to the conventional CDI and MCDI methods.

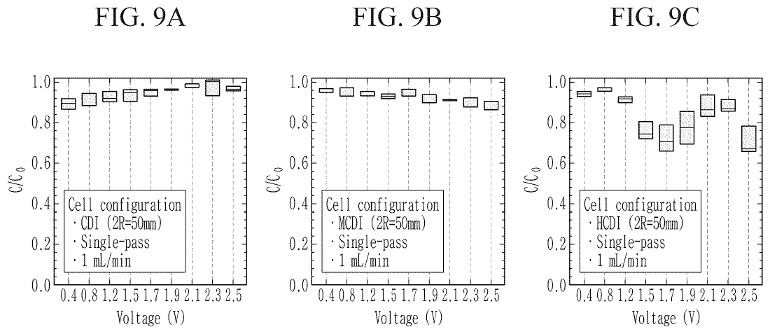

The graphs in FIGS. 9A to 9C are shown to compare and describe the removal rate of 10 ppm silicate ions when using a silicate ion removal device and CDI and MCDI methods according to some embodiments.

FIG. 9A is an experimental value according to the CDI method, FIG. 9B is an experimental value according to the MCDI method, and FIG. 9C is an experimental value using the silicate ion removal system 200 (HCDI) according to the present disclosure.

The above values are for checking the removal rate of the silicate ions 2 according to voltage. The horizontal axis represents voltage and indicates a voltage range of 0.4 to 2.5 V. The vertical axis indicates the current concentration of silicate/initial concentration of silicate.

In FIG. 8 above, the voltage range was 1 to 18 V, but in FIGS. 9A to 9C, it is significant that the silicate ions 2 removal rate was confirmed under conditions of lowering the voltage range.

First, referring to FIGS. 9A to 9B, in the case of CDI and MCDI, even if the voltage is increased, the current concentration of silicate is maintained within the range of 0.8 to 1.0, confirming that silicate is hardly removed when using the CDI or MCDI method.

Specifically, referring to FIG. 9A, in the CDI method, the removal rate of the silicate ions 2 decreases as the voltage increases.

Referring to FIG. 9B, in the MCDI method, as the voltage increases, the removal rate of the silicate ions 2 slightly increases, showing a removal rate of about 10% at 2.5 V.

Referring to FIG. 9C, it can be seen that in the silicate ion removal system 200 (HCDI) according to the present disclosure, the removal rate of the silicate ions 2 increases significantly as the voltage increases.

Specifically, the silicate ions 2 removal rate of 20 to 30% was confirmed between 1.5 to 1.9 V and at 2.5 V, which is a removal rate that is 2 to 3 times higher than that of the conventional CDI and MCDI methods.

As a result, regardless of the strength of the voltage, it can be seen that the removal rate of the silicate ions 2 is significantly higher in the method using the silicate ion removal system 200 (HCDI) according to the present disclosure than in the conventional CDI and MCDI methods.

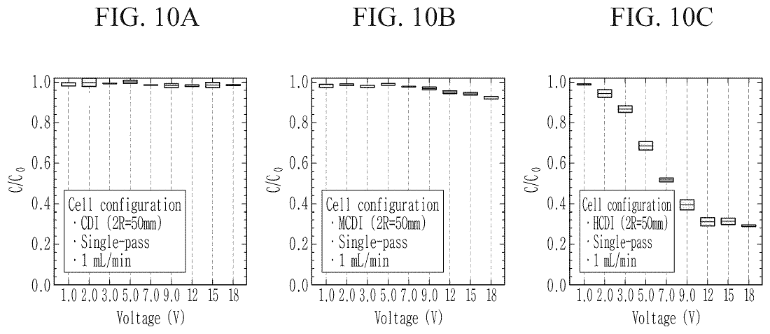

The graphs in FIGS. 10A to 10C are shown to compare and describe the removal rate of 1 ppm silicate ion when using a silicate ion removal device and CDI and MCDI methods according to some embodiments.

FIGS. 9A to 9C above is an experiment for removing 10 ppm of the silicate ions 2, and FIGS. 10A to 10C is an experiment to check the removal rate of 1 ppm of the silicate ions 2.

By setting the initial concentration to 1 ppm and performing an experiment while adjusting the voltage, the fine removal rate of the silicate ions 2 can be confirmed. It is similar to the experiment in FIG. 8, but the initial concentration of silicate was set to 1 ppm.

FIG. 10A is an experimental value according to the CDI method, FIG. 10B is an experimental value according to the MCDI method, and FIG. 10C is an experimental value using the silicate ion removal system 200 (HCDI) according to the present disclosure.

Comparing FIGS. 9A to 9C with graphs (FIGS. 10A to 10C, it can be seen that, overall, the silicate ions 2 are hardly removed in CDI and MCDI (see FIGS. 10A to 10B), and the silicate ions 2 are removed in the silicate ion removal system 200 (HCDI) according to the present disclosure (see FIG. 10C).

Referring to FIG. 10A, when following the CDI method, there is no change in the removal rate of the silicate ions 2 depending on voltage.

Referring to FIG. 10B, in the MCDI method, as the voltage increases, the removal rate of the silicate ions 2 slightly increases, showing a removal rate of about 7% at 18 V.

Referring to FIG. 10C, when using the silicate ion removal system 200 (HCDI) according to the present disclosure, the removal rate of the silicate ions 2 increases from 2.0 V to 12 V. Further, from 12 V, the removal rate of the silicate ions 2 is shown to be within a certain range without significant change (the removal rate of the silicate ions 2 is shown to be about 0% to 75%).

In conclusion, it can be seen that the removal rate of the silicate ions 2 is significantly higher in the method using the silicate ion removal system 200 (HCDI) according to the present disclosure than in the conventional CDI and MCDI methods.

In particular, it can be seen that the removal rate of the silicate ions increased from about 25% to about 75% when the initial concentration of the silicate ions 2 was 1 ppm, compared to the case where the initial concentration of the silicate ions 2 was 10 ppm. This means that the method may be used more effectively to remove the silicate ions 2 contained in trace amounts in semiconductor chemical materials.

In each of the CDI, MCDI, and the silicate ion removal system 200 according to the present disclosure, a comparison of the removal rate of silicate ions 2 according to pH change and voltage change shows that there is no or a low removal rate of the silicate ions 2 in the CDI, MCDI, while the removal rate of the silicate ions 2 is high in the silicate ion removal system 200 according to the present disclosure (see FIGS. 4 to 10).

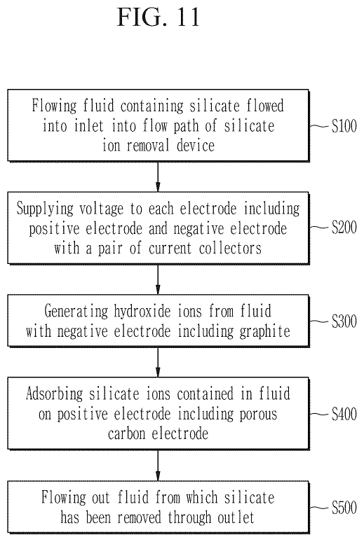

FIGS. 11 to 13 illustrate a silicate ion removal method according to some embodiments.

As shown in FIG. 11, the silicate ion removal method according to the present disclosure may include flowing the fluid 1 containing silicate flowed into the inlet 210 into the flow path 130 of the silicate ion removal device 100 (S100), supplying voltage to each electrode 110 including the positive electrode 112 and the negative electrode 114 by a pair of current collectors 120 (S200), generating hydroxide ions (OH) from the fluid 1 by the negative electrode 114 including graphite (S300), adsorbing the silicate ions 2 contained in the fluid 1 onto the positive electrode 112 including a porous carbon electrode (S400), and flowing out the fluid 1 from which the silicate has been removed through the outlet 220.

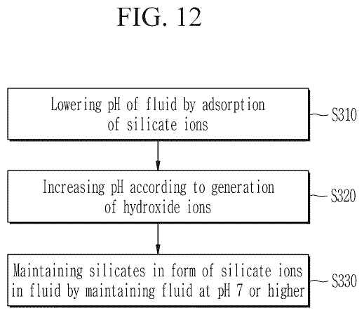

As shown in FIG. 12, the generation of the hydroxide ions (OH) from the fluid 1 by the negative electrode 114 including graphite (S300) may include lowering the pH of the fluid 1 by adsorption of the silicate ions 2 (S310), increasing the pH according to the generation of hydroxide ions (OH) (S320), and maintaining the silicate in the form of the silicate ions 2 in the fluid 1 by maintaining the fluid 1 at pH 7 or higher (S330).

Additionally, the silicate ion removal method may further include supplying a predetermined voltage to each electrode 110 within the range of +20V to −20V by the power supplier 230.

The flow rate of the fluid 1 flowing into the inlet 210 may be in the range of 0.1 to 100 mL/min. Preferably, the flow rate of the fluid 1 may be 4.0 mL/min.

As the flow rate of the fluid 1 increases, the time the fluid 1 stays in the flow path 130 becomes shorter, and the removal rate of the silicate ions 2 decreases accordingly. That is, above a certain flow rate, the removal rate of the silicate ions 2 will decrease.

An experiment was conducted to check the change in the outflow conductivity value according to the change in flow rate, and considering that the conductivity is proportional to the amount of the silicate ions 2 in the fluid 1, it was confirmed that the optimal point of the conductivity value is at a flow rate of 4.0 mL/min.

The silicate ion removal method may further include recovering the silicate ions adsorbed on the positive electrode 112. The silicate ions 2 adsorbed on the positive electrode 112 may be desorbed from the positive electrode 112 by applying an opposite electrode to each electrode 110, and the desorbed silicate ions 2 may be recovered using a recovery solution flowed into the flow path 130.

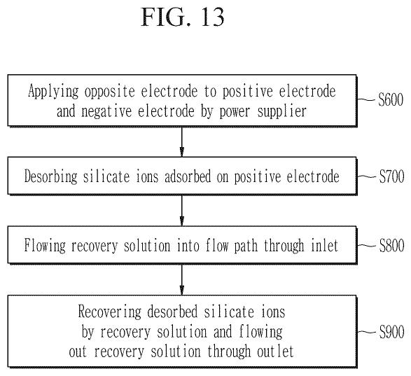

That is, the recovery of the silicate ions 2 may include, as shown in FIG. 13, applying an opposite electrode 110 to each electrode 110 by the power supplier 230 (S600), desorbing silicate ions 2 adsorbed on the positive electrode 112 (S700), flowing a recovery solution into the flow path 130 through the inlet 210 (S800), and recovering the desorbed silicate ions 2 by the recovery solution and flowing out the recovery solution through the outlet 220 (S900).

Before flowing the recovery solution into the flow path 130, the fluid 1 from which the silicate ions 2 have been removed may be discharged to the storage tank 222 or a separate tank (not shown) for storage.

While this disclosure has been described in connection with certain embodiments, it should be understood that the disclosure is not limited to the disclosed embodiments, but, on the contrary, is intended to cover various modifications and equivalent arrangements included within the spirit and scope of the appended claims.

What is claimed is:

1. A silicate ion removal device for removing silicate ions from fluid containing silicates, comprising:
a positive electrode comprising a porous carbon electrode;
a negative electrode spaced apart from the positive electrode and comprising graphite;
a current collector on one side of each of the positive electrode and the negative electrode and configured to supply power to the positive electrode and the negative electrode;
a flow path configured such that the fluid flows between the positive electrode and the negative electrode; and
a cation exchange membrane between the positive electrode and the flow path,
wherein the positive electrode is configured to adsorb the silicate ion.

2. The silicate ion removal device of claim 1, wherein
the negative electrode is configured to generate hydroxide ions from the fluid and to maintain the fluid at pH 7 or higher.

3. The silicate ion removal device of claim 2, wherein
silicate comprising silicate ions in anionic form is in the fluid at pH 7 or higher.

4. The silicate ion removal device of claim 1, wherein
the cation exchange membrane
is configured to allow only the silicate ions among the ions adsorbed on the positive electrode to pass through.

5. A silicate ion removal system, comprising:
an inlet;
a silicate ion removal device configured to receive a fluid from the inlet and to remove silicate ions from the fluid; and
an outlet configured to flow the fluid treated in the silicate ion removal device out of the outlet,
wherein the silicate ion removal device comprises:
a positive electrode including a porous carbon electrode that is configured to adsorb the silicate ions;
a negative electrode spaced apart from the positive electrode, wherein the negative electrode comprises graphite;
a current collector on one side of each of the positive electrode and the negative electrode, the current collector being configured to supply power to the positive electrode and the negative electrode;
a flow path configured such that the fluid flows between the positive electrode and the negative electrode; and
a cation exchange membrane between the positive electrode and the flow path.

6. The silicate ion removal system of claim 5, further comprising:
an inflow pump configured to flow the fluid into the inlet.

7. The silicate ion removal system of claim 5, comprising:
a power supplier configured to supply a predetermined voltage to the silicate ion removal device.

8. The silicate ion removal system of claim 7, comprising
a voltage regulator configured to regulate a supplied voltage.

9. The silicate ion removal system of claim 5, further comprising:
an ion concentration measuring part configured to measure a concentration of the silicate ions contained in the fluid,
wherein the ion concentration measuring part is configured to measure a concentration of silicate ions in at least one fluid flowing into the inlet and the fluid flowing out of the outlet.

10. The silicate ion removal system of claim 5, further comprising:
a flow rate measuring part configured to measure a flow rate of the fluid,
wherein the flow rate measuring part is configured to measure the flow rate of at least one fluid flowing into the inlet and the fluid flowing out of the outlet.

11. The silicate ion removal system of claim 5, further comprising:
a flow rate controller configured to control the flow rate of the fluid flowing into the inlet.

12. The silicate ion removal system of claim 5, wherein
the negative electrode is configured to generate hydroxide ions from the fluid and maintains the fluid at pH 7 or higher.

13. The silicate ion removal system of claim 12, wherein
silicate comprises a silicate ion in anionic form is in the fluid at pH 7 or higher.

14. The silicate ion removal system of claim 5, wherein
the cation exchange membrane is configured to allow only the silicate ions among the ions adsorbed on the positive electrode to pass through.

15. A silicate ion removal method, the method comprising:
flowing a fluid containing silicate into an inlet and into a flow path of a silicate ion removal device;
supplying voltage to a positive electrode and a negative electrode with a pair of current collectors;
generating hydroxide ions from the fluid with the negative electrode, wherein the negative electrode comprises graphite;
adsorbing silicate ions in the fluid on the positive electrode, wherein the positive electrode comprises a porous carbon electrode; and
flowing out the fluid from which the silicate has been removed through an outlet.

16. The silicate ion removal method of claim 15, further comprising
lowering a pH of the fluid by adsorbing the silicate ions;
increasing a pH by generating hydroxide ions; and
maintaining the silicate in a form of silicate ions in the fluid by maintaining the fluid at pH 8 or higher.

17. The silicate ion removal method of claim 15, comprising
supplying a predetermined voltage within a range of +20V to −20V with a power supplier.

18. The silicate ion removal method of claim 15, further comprising:
recovering the silicate ions adsorbed on the positive electrode.

19. The silicate ion removal method of claim 18, comprising:
applying an opposite electrode to the positive electrode and the negative electrode with a power supplier; and
desorbing silicate ions adsorbed on the positive electrode.

20. The silicate ion removal method of claim 19, comprising:
flowing a recovery solution into the flow path through the inlet; and
recovering the desorbed silicate ions with the recovery solution and flowing out the recovery solution through the outlet.
